(19) United States
(12) Patent Application Publication
(10) Pub. No.: US 2023/0166752 A1
(43) Pub. Date: Jun. 1, 2023

(54) SOUND OUTPUT DEVICE

(71) Applicant: LAPIS Technology Co., Ltd., Yokohama (JP)

(72) Inventor: Yuuki KODAMA, Yokohama (JP)

(73) Assignee: LAPIS Technology Co., Ltd., Yokohama (JP)

(21) Appl. No.: 17/990,413

(22) Filed: Nov. 18, 2022

(30) Foreign Application Priority Data
Nov. 30, 2021 (JP) 2021-194060

(51) Int. Cl. B60W 50/14; B60W 40/105; G06F 3/16

(52) U.S. Cl. CPC B60W 50/14; B60W 40/105; G06F 3/165; B60W 2050/0083

(57) ABSTRACT

A sound output device has a sound playback unit that outputs, at any volume, sounds generated by playing back sound data pieces respectively in a first channel and a second channel. The sound playback unit performs a sound change process such that if a travel state of a vehicle is in a first travel state, a sound generated by playing back a sound data piece corresponding to the first travel state is outputted to either one of the first channel and the second channel, and if the travel state of the vehicle changes from the first travel state to a second travel state, the volume of the sound outputted from the one channel is gradually reduced to zero, and a sound generated by playing back a sound data piece corresponding to the second travel state is outputted to another of the first channel and the second channel.

### CROSS REFERENCE TO RELATED APPLICATION

This application is based upon and claims the benefit of priority of the prior Japanese Patent Application No. 2021-194060, filed on Nov. 30, 2021, the entire contents of which are incorporated herein by reference.

### TECHNICAL FIELD

The present invention relates to a sound output device, and in particular, relates to a sound output device that outputs a sound according to the movement speed of a moving body.

### BACKGROUND ART

Electric vehicles and hybrid electric vehicles that run on an electric motor have very low noise at low-speed travel compared to internal combustion engine vehicles, and thus, configurations in which an electric or hybrid electric vehicle is equipped with a vehicle approach notification device that emits a sound announcing the approach of the vehicle to the outside of the vehicle (hereinafter referred to as the “vehicle approach sound”) have been commercialized. When the vehicle is traveling at a lower speed than a prescribed speed, the vehicle approach notification device changes the tone of the vehicle approach sound according to the travel speed.

As such a vehicle approach notification device, a configuration provided with a memory that stores in advance a plurality of pieces of tone generation data with differing tones in association with the travel speed of the vehicle is proposed (e.g., Japanese Patent Application Laid-Open Publication No. 2011-207390).

In such a vehicle approach notification device, first, tone generation data pieces representing synthesized sounds corresponding to the current travel speed of the vehicle are read from the memory. Then, the vehicle approach notification device converts the sound generated by linking the tone generation data pieces sequentially read from the memory into an analog sound signal, and outputs the analog sound signal to the outside of the vehicle using a speaker.

### SUMMARY OF THE INVENTION

In such vehicle approach notification devices, if the travel speed of the vehicle changes, a data piece corresponding to the changed travel speed is newly read from the memory, thereby switching the data piece to be played back. In doing so, the phases of the data pieces are matched so as not to cause any perceived incongruity in the playback sound when the switching is performed.

However, in order to match the phases of the data pieces, a periodic and easy to calculate sound such as a sine wave, a square wave, or a sawtooth wave needs to be used, which has presented the problem that reproduction of a complex sound such as engine noise is difficult.

Also, if the phases of the data pieces are matched in order to reduce the perceived incongruity during switching, then it is necessary to start playback of another data piece after playing back the last sample. This has presented the problem that the switching of data pieces has poorly tracked changes in vehicular speed.

The present invention takes into consideration the above problem, and an object of the present invention is to provide a sound output device that tracks changes in the travel state of a vehicle well.

A sound output device according to the present invention is a sound output device that is configured to output a sound according to a travel state of a vehicle, the sound output device comprising: a sound playback unit that is configured to output, at any volume in a first channel, a sound generated by playing back a sound data piece selected from among a plurality of sound data pieces based on a plurality of sound frequencies that change in a stepwise fashion, that respectively correspond to a plurality of the travel states of the vehicle, and that are respectively set according to the travel state of the vehicle, and output at any volume a sound generated by playing back a sound data piece selected from among the plurality of sound data pieces in a second channel; and a sound output unit that is configured to output a sound signal generated by mixing a sound outputted from the first channel and a sound outputted from the second channel, wherein, if the travel state of the vehicle is a first travel state, the sound playback unit outputs a sound generated by playing back a sound data piece corresponding to the first travel state to either one of the first channel and the second channel, wherein, if the travel state of the vehicle changes from the first travel state to a second travel state, sound change processing is performed such that the volume of the sound outputted from the one channel is gradually reduced to zero, and a sound generated by playing back a sound data piece corresponding to the second travel state is outputted to another of the first channel and the second channel.

A sound playback method according to the present invention is a sound output method to be executed by a sound output device including a sound playback unit that is configured to output, at any volume in a first channel, a sound generated by playing back a sound data piece selected from among a plurality of sound data pieces based on a plurality of sound frequencies that change in a stepwise fashion, that respectively correspond to a plurality of travel states of a vehicle, and that are respectively set according to the travel state of the vehicle, and output at any volume a sound generated by playing back a sound data piece selected from among the plurality of sound data pieces in a second channel, and a sound output unit that is configured to output a sound signal generated by mixing a sound outputted from the first channel and a sound outputted from the second channel, the method comprising: a step of outputting a sound generated by playing back a sound data piece corresponding to a first travel state to either one of the first channel and the second channel if the travel state of the vehicle is the first travel state; and a step of gradually reducing the volume of the sound outputted from the one channel to zero, and outputting a sound generated by playing back a sound data piece corresponding to a second travel state to another of the first channel and the second channel if the travel state of the vehicle changes from the first travel state to the second travel state.

A program according to the present invention is a program for executing, in a sound output device including a sound playback unit that is configured to output at any volume in a first channel a sound generated by playing back a sound data piece selected from among a plurality of sound data pieces based on a plurality of sound frequencies that change in a stepwise fashion, that respectively correspond to a plurality of travel states of a vehicle, and that are respectively set according to the travel state of the vehicle, and output at any volume a sound generated by playing back a sound data piece selected from among the plurality of sound data pieces in a second channel, and a sound output unit that is configured to output a sound signal generated by mixing a sound outputted from the first channel and a sound outputted from the second channel: a step of outputting a sound generated by playing back a sound data piece corresponding to a first travel state to either one of the first channel and the second channel if the travel state of the vehicle is the first travel state; and a step of gradually reducing the volume of the sound outputted from the one channel to zero, and outputting a sound generated by playing back a sound data piece corresponding to a second travel state to another of the first channel and the second channel if the travel state of the vehicle changes from the first travel state to the second travel state.

A recording medium according to the present invention records a program for executing, in a sound output device including a sound playback unit that is configured to output at any volume in a first channel a sound generated by playing back a sound data piece selected from among a plurality of sound data pieces based on a plurality of sound frequencies that change in a stepwise fashion, that respectively correspond to a plurality of travel states of a vehicle, and that are respectively set according to the travel state of the vehicle, and output at any volume a sound generated by playing back a sound data piece selected from among the plurality of sound data pieces in a second channel, and a sound output unit that is configured to output a sound signal generated by mixing a sound outputted from the first channel and a sound outputted from the second channel: a step of outputting a sound generated by playing back a sound data piece corresponding to a first travel state to either one of the first channel and the second channel if the travel state of the vehicle is the first travel state; and a step of gradually reducing the volume of the sound outputted from the one channel to zero, and outputting a sound generated by playing back a sound data piece corresponding to a second travel state to another of the first channel and the second channel if the travel state of the vehicle changes from the first travel state to the second travel state.

According to the sound output device of the present invention, which outputs a sound according to the travel state of the vehicle, it is possible to achieve good tracking of changes in the travel state.

### BRIEF DESCRIPTION OF THE DRAWINGS

FIG. 1 is a block diagram showing a configuration of a vehicle approach notification system.

FIG. 2 is a block diagram showing an internal configuration of an approach notification device.

FIG. 3 is a diagram showing an example of a memory map of a sound memory.

FIG. 4 is an image that schematically shows playback of sounds of each channel according to changes in vehicular speed.

FIG. 5 is a flowchart showing a processing routine for sound playback according to the present embodiment.

FIG. 6 is a flowchart showing a processing routine for sound playback according to a modification example.

### DETAILED DESCRIPTION OF EMBODIMENTS

A suitable embodiment of the present invention will be explained below in detail. In the description of an embodiment and the affixed drawings below, parts that are substantially the same or equivalent to each other are assigned the same reference characters.

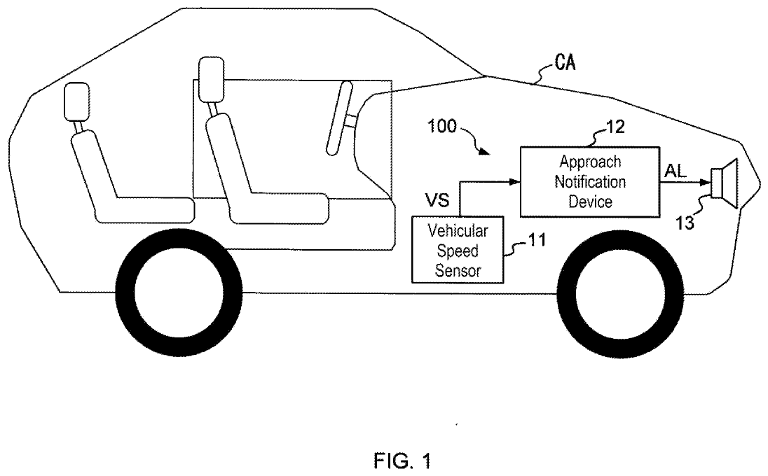

FIG. 1 is a block diagram showing a configuration of a vehicle approach notification system 100 according to the present invention. The vehicle approach notification system 100 is installed in a vehicle CA, and is a sound output system that issues a notification that the vehicle CA is approaching by outputting a sound according to the travel speed of the vehicle CA (that is, the vehicular speed).

The vehicle approach notification system 100 has a vehicular speed sensor 11, an approach notification device 12, and a speaker 13.

The vehicular speed sensor 11 detects the travel speed of the vehicle CA, and supplies a speed signal VS indicating information regarding the travel speed to the approach notification device 12.

The approach notification device 12 generates a vehicle approach sound signal AL having frequency components in the audible range corresponding to the travel speed represented by the speed signal VS, and supplies the vehicle approach sound signal AL to the speaker 13.

The speaker 13 is installed in the front bumper of the vehicle CA, for example, and emits to the space outside the vehicle CA an audible sound AS based on the vehicle approach sound signal AL as the vehicle approach sound.

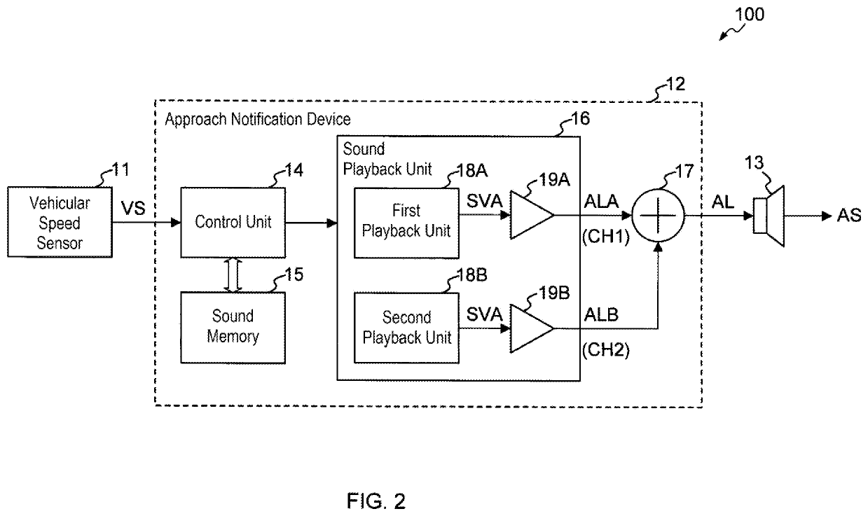

FIG. 2 is a block diagram showing an internal configuration of the approach notification device 12. The approach notification device 12 includes a control unit 14, a sound memory 15, a sound playback unit 16, and a mixer 17.

The control unit 14 receives the speed signal VS from the vehicular speed sensor 11, reads from the sound memory 15 a sound data piece corresponding to the travel speed represented by the speed signal VS, and supplies the sound data piece to the sound playback unit 16. The control unit 14 receives supply of the speed signal VS from the vehicular speed sensor 11 for each of interval periods SP to confirm the travel speed. In the present embodiment, the interval period SP is set to be a period of time sufficiently shorter than one second.

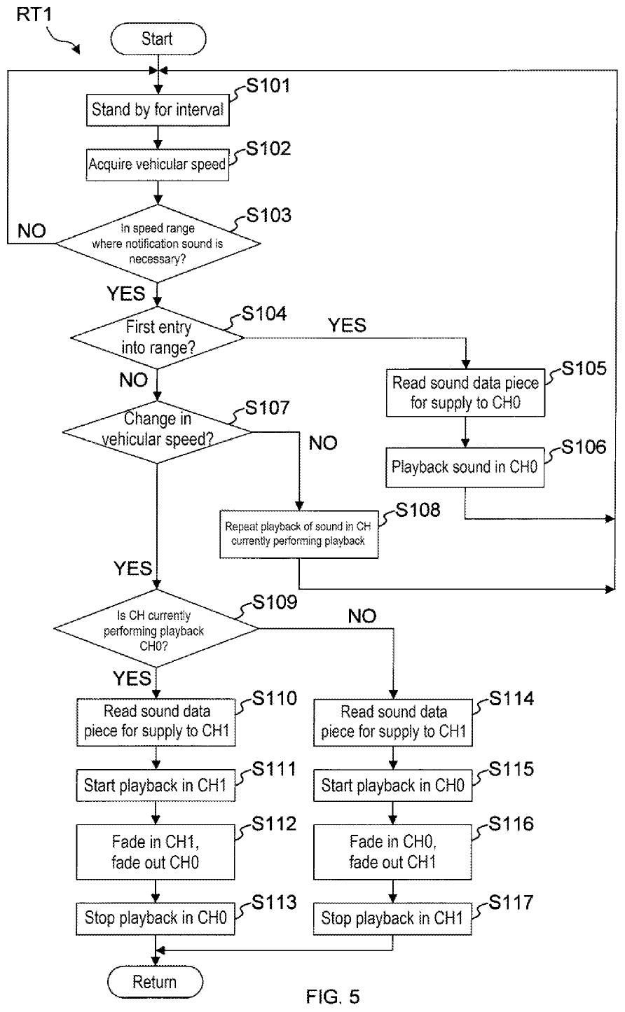

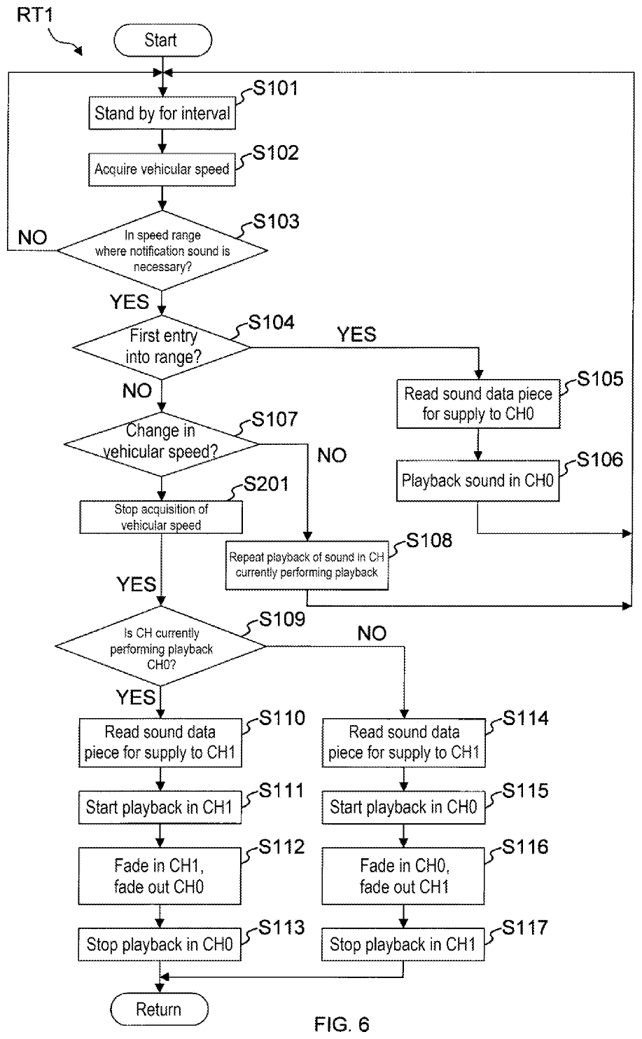

The sound memory 15 is constituted of a storage medium such as a NAND or NOR flash memory, a non-volatile semiconductor memory such as a PROM (programmable ROM), or a magnetic recording hard disk. The sound memory 15 stores sound data pieces AF1 to AF(S), which individually represent each of a plurality of vehicle approach sounds having different frequency components, in association with each of a plurality of speed ranges into which the range of travel speeds, for which the generation of the vehicle approach sound is required, is divided. The sound memory 15 may also store a program for performing the operations described further on with reference to FIGS. 5 and 6. The program may include computer-executable instructions that when executed by a computer processor cause the operations to be performed. The program, however, need not be stored in the sound memory 15 and may be stored in a different memory or on a removable, portable, non-transitory computer-or-machine-readable medium such as a compact disc, a mass storage device or the like.

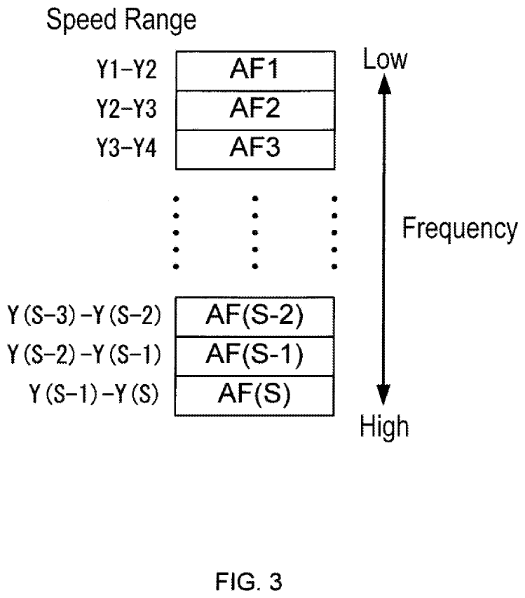

FIG. 3 is a diagram showing an example of a memory map of a sound memory 15. The sound memory 15 stores sound data pieces AF1 to AF(S) in association with the each of S (S being an integer of 2 or greater) speed ranges into which the range of travel speeds, for which the vehicle approach sound is generated, is divided. The sound data pieces AF1 to AF(S) are provided such that the frequency changes in a stepwise fashion.

For example, in the sound memory 15, the sound data piece AF1 is stored in association with a speed range from a speed Y1 to a speed Y2 (e.g., 0 to 0.5 km/h). Also, in the sound memory 15, the sound data piece AF2 associated with a vehicle approach sound at a higher frequency than the sound data piece AF1 is stored in association with a range from a speed Y2 to a speed Y3 (e.g., 0.5 to 1.0 km/h). Additionally, in the sound memory 15, combined wave data AF3 associated with a vehicle approach sound at a higher frequency than the sound data piece AF2 is stored in association with a range from a speed Y3 to a speed Y4 (e.g., 1.0 to 1.5 km/h).

Each of the sound data pieces AF1 to AF(S) is set such that the length of the played back sound is sufficiently longer than the interval period SP for vehicular speed confirmation. It is preferable that the sound played back for each of the sound data pieces AF1 to AF(S) be one second or longer.

Returning to FIG. 2, the sound playback unit 16 plays back the sound data pieces read by the control unit 14 from the sound memory 15 on the basis of the travel speed of the vehicle CA, and outputs the sound data pieces as sound signals. The sound playback unit 16 has the function of playing back sounds simultaneously in a channel 0 and a channel 1.

The volumes of the sound playback in the channel 0 and the sound playback in the channel 1 can be freely changed. The sound playback unit 16 can, for example, perform a process for gradually increasing the playback volume from zero to a prescribed volume (hereinafter referred to as “fade-in”) and a process for gradually decreasing the playback volume to zero (hereinafter referred to as “fade-out”) for the channel 0 and the channel 1, respectively.

The sound playback unit 16 has a first playback unit 18A, a second playback unit 18B, a first amplifier 19A, and a second amplifier 19B.

The first playback unit 18A is a first sound playback unit that plays back the sound data pieces. The first playback unit 18A plays back the sound data pieces in the channel 0 (also referred to as CH0).

The second playback unit 18B is a second sound playback unit that plays back the sound data pieces. The second playback unit 18B plays back the sound data pieces in the channel 1 (also referred to as CH1).

The first amplifier 19A amplifies a sound signal SVA played back by the first playback unit 18A and supplies the sound signal SVA to the mixer 17 as a playback sound signal ALA of the channel 0.

The second amplifier 19B amplifies a sound signal SVB played back by the second playback unit 18B and supplies the sound signal SVB to the mixer 17 as a playback sound signal ALB of the channel 1.

In the present embodiment, the sound playback unit 16 controls the playback volume of the first playback unit 18A and the second playback unit 18B, respectively, when playing back the sound data pieces in the channel 0 and the channel 1 simultaneously, thereby performing a sound modification process of fading in the sound of one channel while fading out the sound of the other channel (so-called crossfade). If, for example, the playback of a sound data piece in channel 1 is started while a sound data piece is being played back in the channel 0, the sound of the channel 1 is faded in while fading out the sound of the channel 0. Similarly, if the playback of a sound data piece in channel 0 is started while a sound data piece is being played back in the channel 1, the sound of the channel 0 is faded in while fading out the sound of the channel 1.

The mixer 17 receives supply of the playback sound signal ALA of the channel 0 and the playback sound signal ALB of the channel 1 outputted from the sound playback unit 16, and supplies a mixture thereof to the speaker 13 as the vehicle approach sound signal AL.

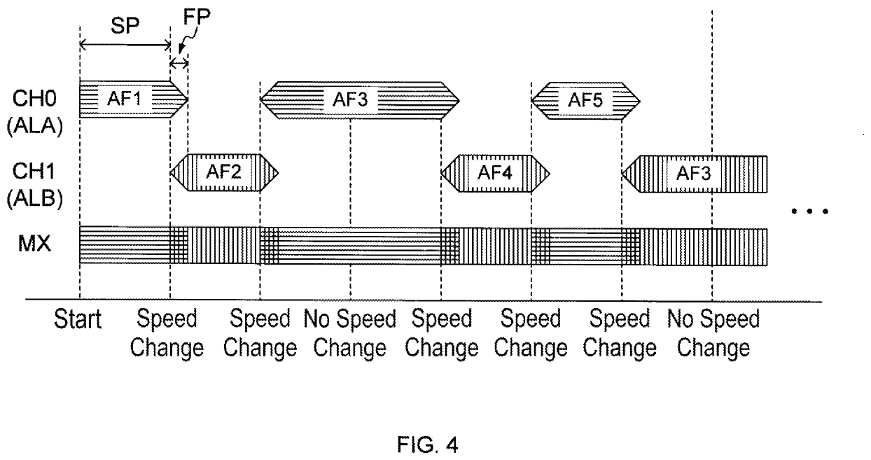

FIG. 4 is an image that schematically shows playback of sounds of each channel according to changes in vehicular speed.

If the vehicle CA starts traveling and the vehicular speed thereof reaches the first speed range Y1-Y2 where the vehicle approach sound needs to be generated, for example, then the control unit 14 reads the sound data piece AF1 from the sound memory 15 and supplies the sound data piece AF1 to the sound playback unit 16. The first playback unit 18A of the sound playback unit 16 plays back the sound data piece AF1 in the channel 0.

If the vehicular speed of the vehicle CA changes to the speed range Y2-Y3, then the control unit 14 reads the sound data piece AF2 from the sound memory 15 and supplies the sound data piece AF2 to the sound playback unit 16. The second playback unit 18B of the sound playback unit 16 starts playback of the sound data piece AF2 in the channel 1. In this case, the first playback unit 18A fades out the currently playing sound in the channel 0 and the second playback unit 18B fades in the sound of the channel 1. As a result, crossfading (sound modification process) between the sounds of both channels is conducted during a fade period FP shown in FIG. 4, and the vehicle approach sound signal AL outputted from the approach notification device 12 shifts from a sound signal based on the sound data piece AF1 to a sound signal based on the sound data piece AF2. The first playback unit 19A that has performed the fade out process stops playback after completing playback of the one sound data piece to the end.

Similarly thereafter, every time the vehicular speed of the vehicle CA exceeds the speed range (that is, Y1-Y2, Y2-Y3, Y3-Y4, etc.) corresponding to each of the sound data pieces shown in FIG. 3 during the interval period SP for vehicular speed confirmation, crossfading is performed between the channel 0 and the channel 1 and playback of the sound data pieces in the respective channels is alternately ended and started. In the present embodiment, as described above, the length of the sound from playing back each of the sound data pieces AF1 to AF(S) is greater than the interval period SP for vehicular speed confirmation, and thus, confirmation of the vehicular speed is performed at least once during playback of each sound data piece.

The fade period FP is set so as to be shorter than the interval period SP for vehicular speed confirmation. Also, crossfading is executed so as to start immediately after confirming the vehicular speed and end during the interval period SP.

On the other hand, if the vehicular speed of the vehicle CA does not cross the bounds of the speed range corresponding to each sound data piece during the interval period SP for vehicular speed confirmation, then either one of the first playback unit 18A and the second playback unit 18B currently playing back the sound data piece continues repeatedly playing back the same sound data piece.

Next, the process operation for sound playback by the approach notification device 12 of the present embodiment will be described.

FIG. 5 is a flowchart showing a processing routine for sound playback according to the present embodiment.

The control unit 14 stands by for the interval period SP (STEP 101), and acquires speed information indicating the vehicular speed of the vehicle CA on the basis of the speed signal VS of the vehicular speed from the vehicular speed sensor 11 (STEP 102).

The control unit 14 determines whether the vehicular speed of the vehicle CA is in a speed range where output of an approach notification sound is necessary (STEP 103). If it is determined that the speed range is not one where output of the approach notification sound is necessary (STEP 103: NO), then the process returns to STEP 101 and the control unit 14 stands by for the interval period SP and acquires the speed information.

On the other hand, if it is determined that the speed range is one where output of the approach notification sound is necessary (STEP 103: YES), then it is determined whether the vehicular speed of the vehicle CA has reached the speed range for the first time, or in other words, whether the vehicular speed entered the speed range from outside of the speed range (STEP 104). Here, if the vehicular speed of the vehicle CA changes from a speed outside of the speed range of Y1-Y(S) indicated in FIG. 3 to within the speed range Y1-Y(S), for example, then the vehicular speed is determined to have entered the speed range for the first time.

Upon determining that the vehicular speed has entered the speed range for the first time (STEP 104: YES), the control unit 14 reads from the sound memory 15 a sound data piece corresponding to the vehicular speed acquired in STEP 102, and supplies the sound data piece to the first playback unit 18A, which handles playback of the channel 0 (CH0) (STEP 105). The first playback unit 18A plays back the sound data piece in the channel 0 (STEP 106).

If, on the other hand, it is determined that the vehicular speed has not entered the speed range for the first time (STEP 104: NO), then the control unit 14 determines whether the change in speed from the vehicular speed confirmed during the previous vehicular speed confirmation to the vehicular speed acquired in STEP 102 exceeds the bounds of the speed range corresponding to each sound data piece (i.e., Y1-Y2, Y2-Y3, Y3-Y4, etc. in FIG. 3) (STEP 107).

Upon determining that the change in vehicular speed does not exceed the bounds of the speed range (STEP 107: NO), the playback unit of the channel currently playing back the sound data piece (i.e., either one of the first playback unit 18A and the second playback unit 18B) repeats playback of the same sound data piece as the previous sound data piece (STEP 108).

On the other hand, if it is determined that the change in vehicular speed exceeds the bounds of the speed range (STEP 107: YES), the control unit 14 confirms whether the channel currently playing back the sound data piece is the channel 0 (CH0), or in other words, whether playback is being performed by the first playback unit 18A (CH0) or the second playback unit 18B (CH1) (STEP 109).

Upon determining that the channel currently playing back the sound data piece is the channel 0 (STEP 109: YES), the control unit 14 reads from the sound memory 15 a sound data piece corresponding to the vehicular speed acquired in STEP 102, and supplies the read sound data piece to the second playback unit 18B of the sound playback unit 16 (STEP 110). The second playback unit 18B starts playback of the sound in the channel 1 (STEP 111).

The sound playback unit 16 controls the playback volume of the first playback unit 18A to fade out the sound in the channel 0 and controls the playback volume of the second playback unit 18B to fade in the sound in the channel 1 (STEP 112).

The first playback unit 18A gradually reduces the volume while playing back one instance of the sound data piece to the end and then stops playback (STEP 113).

In step 109, upon determining that the channel currently playing back the sound data piece is the channel 1 (i.e., not the channel 0) (STEP 109: NO), the control unit 14 reads from the sound memory 15 a sound data piece corresponding to the vehicular speed acquired in STEP 102, and supplies the read sound data piece to the first playback unit 18A of the sound playback unit 16 (STEP 114). The first playback unit 18A starts playback of the sound in the channel 0 (STEP 115).

The sound playback unit 16 controls the playback volume of the first playback unit 18A to fade out the sound in the channel 0 and controls the playback volume of the second playback unit 18B to fade in the sound in the channel 1 (STEP 116).

The second playback unit 18B gradually reduces the volume while playing back one instance of the sound data piece to the end and then stops playback (STEP 117).

As described above, the approach notification device 12 of the present embodiment selects among a plurality of sound data pieces with different frequencies (pitches) according to the travel speed of the vehicle, and playback is performed while switching between the channel 0 and the channel 1. When switching channels, the sound outputted from one channel is faded out and output of sound from the other channel is started and faded in.

According to this configuration, it is possible to artificially change the frequency (pitch) of the sound data piece by switching channels. Also, it is possible to switch between sounds smoothly through crossfading, and thus, it is possible to switch sound data pieces to be played back without any incongruity perceived by the listener.

Also, by playing back the sound while switching channels through crossfading, it is possible to switch the outputted sound to the sound generated by playing back the other sound data piece without waiting for the end of playback of the first sound data piece. Thus, according to the approach notification device of the present embodiment, it is possible to increase the degree to which the change in vehicular speed is tracked and smoothly switch sound frequencies.

Also, according to the approach notification device 12 of the present embodiment, playback of the sound data pieces by the two channels (playback units) is alternately switched according to changes in the vehicular speed, and thus, even if the IC of the sound playback unit 16 did not have high sound processing capabilities, it is possible to change the frequency of the outputted sound signal according to the vehicular speed.

The present invention is not limited to the embodiment above. An example was described in the present embodiment in which the fade period FP is shorter than the interval period SP, and crossfading is executed so as to finish during the interval period SP. However, a configuration may be adopted in which such a limitation is not provided to the fade period FP and confirmation of the vehicular speed is stopped during execution of crossfading.

FIG. 6 is a flowchart showing a processing routine for sound playback according to a modification example. The processes up to STEP 108 are the same as the processing routine shown in FIG. 5, and thus, explanation thereof is omitted here.

In STEP 107, upon determining that there was a change in vehicular speed exceeding the bounds of the speed range (STEP 107: YES), the control unit 14 stops confirming the vehicular speed based on the speed signal VS (STEP 201).

After STEP 201, the control unit 14 executes STEP 109. Depending on the result of STEP 109 the control unit 14 executes STEPs 110 to 113 or STEPs 114 to 117. After stoppage of playback in STEP 113 or 117, the process returns to STEP 101 and the control unit 14 resumes confirmation of the vehicular speed.

Also, in the present embodiment, an example was described in which the speed signal VS representing information of the travel speed of the vehicle CA was acquired from the vehicular speed sensor 11, and the sound data piece to be played back and the channel were switched according to the change in vehicular speed. However, the configuration is not limited thereto, and switching of the sound data piece and the channel may be performed on the basis of a travel state aside from the travel speed of the vehicle.

For example, a configuration may be adopted in which switching of sound data pieces and channels is performed according to the degree to which the accelerator pedal is pressed on the basis of information from an accelerator sensor installed in the vehicle CA instead of the vehicular speed sensor 11.

Also, in the present embodiment, an example was described of preparing sound data pieces AF1 to AF(S) provided such that the frequency changes in a stepwise fashion and changing the frequency of the sound according to a change in the travel state of the vehicle. However, a configuration may be adopted in which a plurality of sound data pieces that differ in elements other than frequency (e.g., sound data pieces created by an equalizer or the like such that sound effects thereof differ in a stepwise fashion) are prepared, and the sound data pieces are selectively played back according to changes in the travel state of the vehicle.

Also, in the present embodiment, an example was described of an approach notification device that generates, from the vehicle, a vehicle approach sound that notifies a pedestrian of the approach of a vehicle, but the generated sound is not limited to a vehicle approach sound. That is, it is possible to apply the present invention to any sound output device for which it is necessary to change the tone in real time according to some input such as the travel state of a vehicle.

What is claimed is:

1. A sound output device that is configured to output a sound according to a travel state of a vehicle, the sound output device comprising:
a sound playback unit that is configured to output, at any volume in a first channel, a sound generated by playing back a sound data piece selected from among a plurality of sound data pieces based on a plurality of sound frequencies that change in a stepwise fashion, that respectively correspond to a plurality of the travel states of the vehicle, and that are respectively set according to the travel state of the vehicle, and output at any volume a sound generated by playing back a sound data piece selected from among the plurality of sound data pieces in a second channel; and
a sound output unit that is configured to output a sound signal generated by mixing a sound outputted from the first channel and a sound outputted from the second channel,
wherein, if the travel state of the vehicle is a first travel state, the sound playback unit outputs a sound generated by playing back a sound data piece corresponding to the first travel state to either one of the first channel and the second channel, and
wherein, if the travel state of the vehicle changes from the first travel state to a second travel state, a sound change process is performed such that a volume of the sound outputted from the one channel is gradually reduced to zero, and a sound generated by playing back a sound data piece corresponding to the second travel state is outputted to another of the first channel and the second channel.

2. The sound output device according to claim 1,
wherein, in the sound change process, the sound playback unit gradually reduces the volume of the sound outputted from the one channel to zero and gradually increases a volume of the sound outputted from said other channel until a prescribed volume is reached.

3. The sound output device according to claim 1,
wherein the travel state of the vehicle is a travel speed of the vehicle,
wherein each of the plurality of sound data pieces corresponds to each speed range among a plurality of speed ranges into which a range of speeds, for which output of a sound according to the travel speed is required, is divided, and
wherein the sound playback unit performs the sound change process according to a change in the travel state in which the travel speed of the vehicle changes from a first speed range to a second speed range.

4. The sound output device according to claim 1,
wherein the sound playback unit performs the sound change process based on a travel state acquired for a prescribed confirmation period, and
wherein a period during which the sound playback unit performs the sound change process is shorter than the prescribed confirmation period.

5. The sound output device according to claim 4,
wherein the sound generated by each of the plurality of sound data pieces is longer than the prescribed confirmation period.

6. The sound output device according to claim 1, further comprising:
a control unit that is configured to acquire state information indicating the travel state of the vehicle and control the sound playback unit based on the acquired state information,
wherein the control unit stops acquiring the state information during a period in which the sound playback unit performs the sound change process.

7. A sound output method to be executed by a sound output device including a sound playback unit that is configured to output, at any volume in a first channel, a sound generated by playing back a sound data piece selected from among a plurality of sound data pieces based on a plurality of sound frequencies that change in a stepwise fashion, that respectively correspond to a plurality of travel states of a vehicle, and that are respectively set according to a travel state of the vehicle, and output at any volume a sound generated by playing back a sound data piece selected from among the plurality of sound data pieces in a second channel, and a sound output unit that is configured to output a sound signal generated by mixing a sound outputted from the first channel and a sound outputted from the second channel, the sound output method comprising:
a step of outputting a sound generated by playing back a sound data piece corresponding to a first travel state to either one of the first channel and the second channel if the travel state of the vehicle is the first travel state; and
a step of gradually reducing a volume of the sound outputted from the one channel to zero, and outputting a sound generated by playing back a sound data piece corresponding to a second travel state to another of the first channel and the second channel if the travel state of the vehicle changes from the first travel state to the second travel state.

8. A non-transitory machine-readable medium storing a program, the program when executed by a processor causing to be performed operations including:
in a sound output device including a sound playback unit that is configured to output, at any volume in a first channel, a sound generated by playing back a sound data piece selected from among a plurality of sound data pieces based on a plurality of sound frequencies that change in a stepwise fashion, that respectively correspond to a plurality of travel states of a vehicle, and that are respectively set according to the travel state of the vehicle, and output at any volume a sound generated by playing back a sound data piece selected from among the plurality of sound data pieces in a second channel, and a sound output unit that is configured to output a sound signal generated by mixing a sound outputted from the first channel and a sound outputted from the second channel:
a step of outputting a sound generated by playing back a sound data piece corresponding to a first travel state to either one of the first channel and the second channel if the travel state of the vehicle is the first travel state; and
a step of gradually reducing a volume of the sound outputted from the one channel to zero, and outputting a sound generated by playing back a sound data piece corresponding to a second travel state to another of the first channel and the second channel if the travel state of the vehicle changes from the first travel state to the second travel state.
